(19) United States
(12) Patent Application Publication
(10) Pub. No.: US 2012/0141688 A1
(43) Pub. Date: Jun. 7, 2012

(54) Release Agent Applicator and Method of Using Same

(75) Inventor: Karl Heinze, West Chicago, IL (US)

(73) Assignee: Prince Castle LLC, Carol Stream, IL (US)

(21) Appl. No.: 12/961,708

(22) Filed: Dec. 7, 2010

(51) Int. Cl. B05D 1/28; B05C 1/08

(52) U.S. Cl. 427/428.05; 118/258

(57) ABSTRACT

Water, oils and other liquid release agents are thinly and uniformly applied to hot cooking surfaces using an open-cell silicone foam structure. The foam is selected to have characteristics. It does not degrade chemically or physically when exposed to the liquid release agents or high-temperatures commonly encountered when frying foods.

### BACKGROUND

Many foods are cooked by frying them on a flat surface having a layer of cooking oil on the surface. The oil is important because it reduces or even eliminates the tendency of foods to stick to a hot frying surface.

Many cooks, restaurants and food service providers prefer to fry foods using a layer of cooking oil that is both thin and spread uniformly. In the prior art, cooking oil and other release agents are often applied using a spray or a brush. Spraying requires the use of an aerosol. Brushing an oil or other release agent tends to apply too much of the oil or release agent. Over applying cooking oil or other release agent wastes material. It can also adversely affect food quality and it makes clean up more difficult. An apparatus and method for applying a release agent would be an improvement over the prior art.

### BRIEF DESCRIPTION OF THE DRAWINGS

FIG. 1 is a perspective view of a release agent applicator;

FIG. 2 is a perspective view of an open cell foam structure shaped like a tube;

FIG. 3 is an end view of the structure shown in FIG. 2;

FIG. 4 is a side view of the structure shown in FIG. 2;

FIG. 5 is an exploded view of the structure shown in FIG. 1;

FIG. 6 is a perspective view of an alternate embodiment of a release agent applicator; and

FIG. 7 is a perspective view another alternate embodiment of a release agent applicator.

### DETAILED DESCRIPTION

As used herein, a “release agent” is any type of liquid that is applied to a surface to prevent a material or substance from becoming attached to the surface or to reduce the tendency of a material or substance to become attached to the surface. Cooking oil is a release agent. Water is also a release agent. When cooking oil is applied to a cooking surface such as a frying pan, it prevents foods from sticking to the surface.

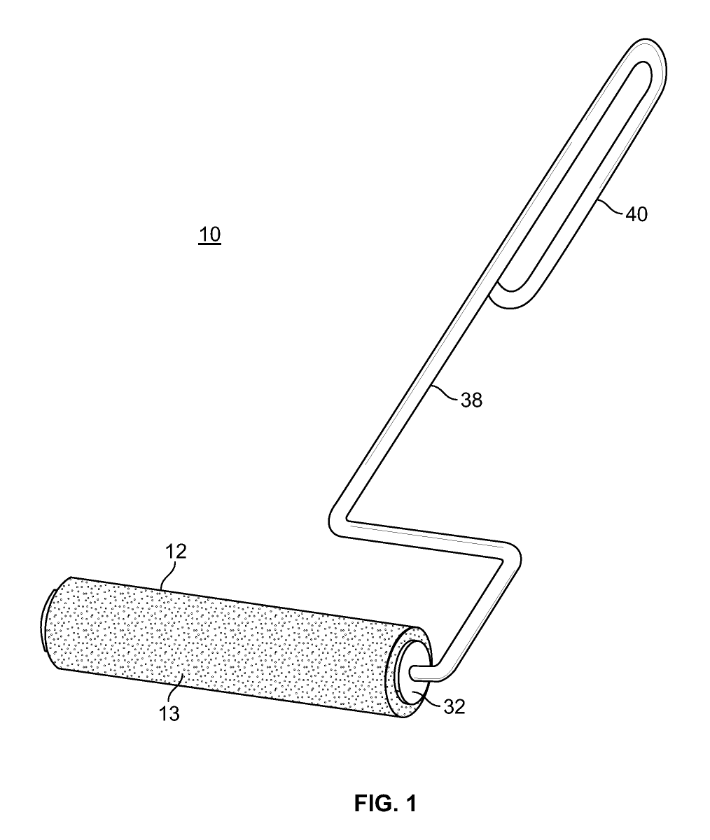

FIG. 1 is a perspective view of a preferred embodiment of a release agent applicator 10. The release agent applicator 10 depicted in FIG. 1 is comprised of a silicon-based open-cell foam structure 12, so called because the material is comprised of very small, normally-empty cells, the walls of which are made of material that is elastic. The cells have at least one opening through which a liquid like cooking oil can pass freely. An open-cell foam material from which an open-cell foam structure is made is thus elastic and porous. The cell openings are represented by stippling 13.

Some liquid release agents are characterized in part by viscosity. The foam structures usable as a liquid release agent applicator are preferably capable of absorbing liquids that are commonly used as release agents but later releasing or discharging them onto a cooking surface. Liquid release agents include vegetable and other cooking oils commonly used to fry foods. Preferable materials for a foam structures are therefore preferably able to absorb and release such liquids.

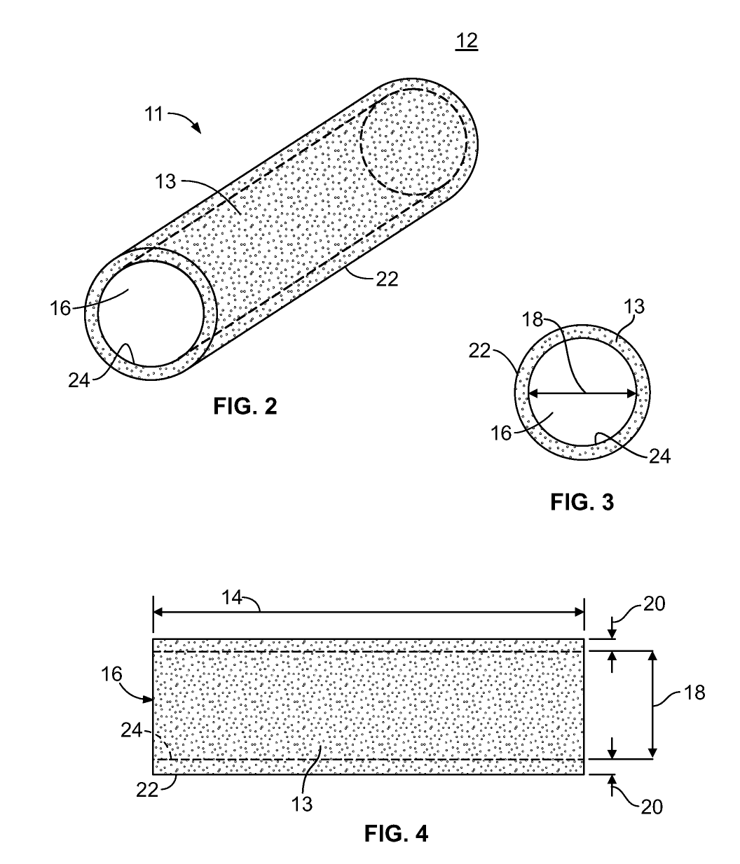

As shown in FIGS. 2, 3 and 4, the foam structure 12 is shaped to form an elongated hollow tube 11 having a length 14, a hollow interior 16 defined by an inside diameter 18, a wall thickness 20 and an outside surface 22. The wall thickness 20 is defined by the distance separating the inside surface 24 of the tube-shaped structure 12 and the outside surface 22 of the structure 12.

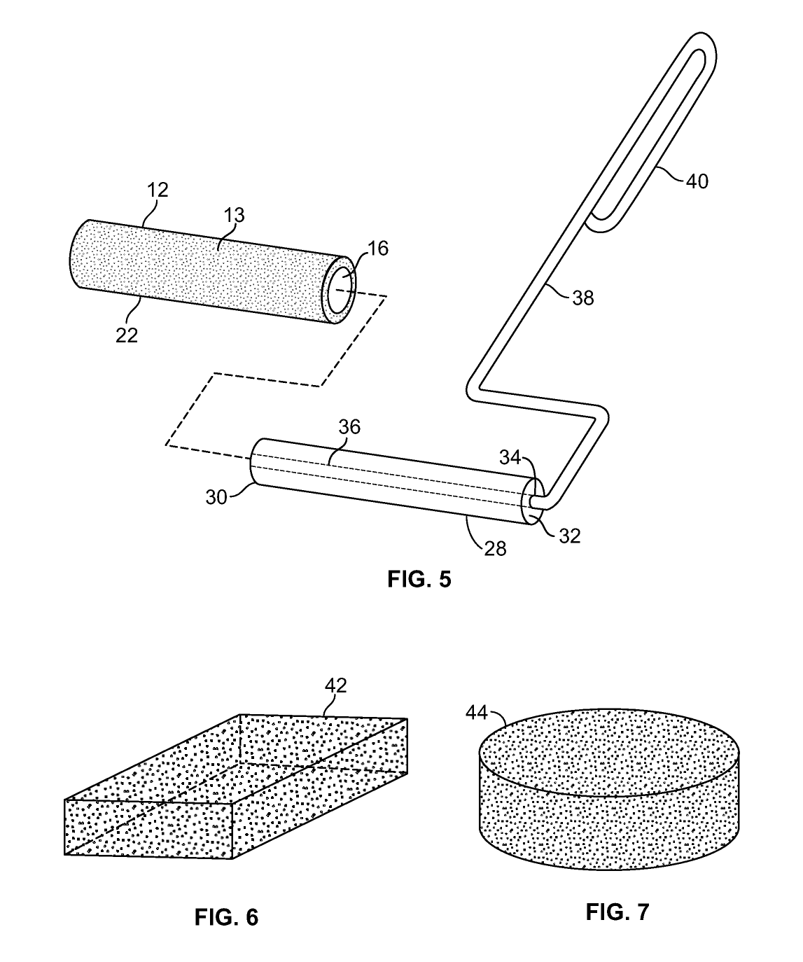

The inside diameter 18 of the tube-shaped structure 12 is sized to provide a friction fit between the inside surface 24 and an exterior surface 26 of a plastic, elongated sleeve 28, seen best in FIG. 5. More particularly, the inside diameter 18 of the tube 11 is slightly less than the outside diameter of the plastic sleeve 28.

FIG. 5 shows that the sleeve 28 has two opposing ends, 30 and 32, which enclose the interior of the sleeve 28 as well as the foam structure 12. The opposing ends 30 and 32 have holes 34 formed in them to receive an axle 36 that extends through the sleeve 28 and through the ends 30 and 32 that enclose the interior of the sleeve 28.

The axle 36 is formed from a heavy gauge wire or rod. It has a first diameter. The holes 34 through the ends 30 and 32 have a second diameter, just slightly greater than the first diameter of the axle 36. The first and second diameters are different from each other but selected so that the ends 30 and 32, which are attached to the sleeve 28, can rotate freely on the axle 36. The loose fit between the holes 34 and axle 36 thus allow the sleeve 28 and the tube-shaped, open-cell silicone-based foam structure that is attached to the sleeve 28 by a friction fit to rotate together.

The heavy gauge wire or rod that comprises the axle 36 is preferably bent to form a handle 38 as shown in FIG. 1 and FIG. 5. The handle 38 has a grip 40 that allows a user to grasp the handle 38 to operate the release agent applicator 10.

Operating the release agent applicator 10 includes immersing the foam structure 12 into a release agent, such as a cooking oil so that the open-cell foam can absorb or pick up oil to be applied to a surface. Vegetable oil-based cooking oils are well known release agents and are not shown in the figures because they are well known to those of ordinary skill in the art. Immersing the foam structure into a release agent coats the surfaces of the foam structure. It also tends to fill the open cells of the foam structure with release agent.

After the open-cell foam is immersed in a liquid release agent, the release agent is applied to a surface by translating the foam structure over the surface. Release agent that flowed into the cells via the aforementioned holes in the cells passes out of the cells, via the holes in the cells and onto a surface. A uniform-thickness layer of release agent can thus be controllably applied to a surface. The thickness of the release agent applied to a surface will depend on factors that include surface characteristics of the foam structure 12, the viscosity of the release agent and the roughness of the surface to which a release agent is applied.

The ability of the foam structure to absorb or pick up a liquid release agent is determined in part by the number of open-cell pores per unit area or per unit length. The ability of the foam structure to pick up a liquid release agent increases as the open-cell pore density per unit area or per unit length. In a preferred embodiment, the foam structure was made from an open-cell silicone foam having an open-cell pore density of about 90 pores per lineal inch. Testing revealed that other pore densities provide acceptable application results. Pore densities can range from about 25 up to about 400 pores per inch however, significantly better results are obtained with pore densities between about 60 and 100 pores per lineal inch.

When the release agent applicator is used to apply cooking oils and other liquid foodstuffs to surfaces, it is important that the foam material have physical and chemical characteristics that are compatible for use with cooking, cooking oils and other foodstuffs. The foam material should comply with food-safe laws and regulations that govern the use of materials used to prepare foods, such as the Food and Drug Administration regulations in 21 C.F.R. §177.2600. Among other things, the material should not break down or degrade when exposed to cooking oils and the relatively high temperatures commonly used to cook foods.

The foam structure 12 is also preferably viscoelastic. Viscoelastic materials demonstrate a time-dependent elastic strain. Elastic deformation of the material continues after the application of a stress and, upon load release, a finite amount of time is required for the material's shape to recover completely.

The foam material used in a preferred embodiment is the Rogers Corporation product number MF1-6535. The same foam material is believed to be used padding in vehicle seats and which is also viscoelastic.

An important feature of the MF1-6535 open-cell silicone foam is that it is physically and chemically stable and complies with governmental regulations. In tests, it did not breakdown when exposed to temperatures as high as five hundred degrees Fahrenheit. (500° F.). It also did not break down when exposed to cooking oils. Open-cell silicon foam materials become brittle at high temperatures, which can induce cross-linking between the silicon chain molecules, which reduces the elasticity of the material.

While the preferred embodiment of the release agent applicator is an elongated tube that is friction-fit to sleeve that rotates on an axle that can be controlled from a handle, alternate embodiments of a release applicator are comprised of an open-cell foam structure itself, i.e., without a sleeve, axle or handle. One alternate embodiment is an amorphous, i.e., substantially shapeless, pad of open cell foam material. Amorphous-shaped foam structures resemble natural Sponge. Another alternate embodiment is a parallelepiped-shaped pad 42 as shown in FIG. 5. A disk 44 is yet another shape.

Release agents are applied by the alternate embodiments by a user grasping the foam structure by hand, immersing the foam structure into a volume of liquid release agent, applying the open-cell foam structure to a cooking surface and then translating the open-cell foam structure over the cooking surface, i.e., moving it back and forth and/or around the surface.

The foregoing description is for purposes of illustration only. The true scope of the invention is defined by the appurtenant claims.

What is claimed is:

1. A release agent applicator comprising:
a foam structure, comprised of a plurality of cells, the cells defined by a wall with at least one opening through which the release agent can pass.

2. The release agent applicator of claim 1, wherein the foam structure is comprised of an open cell foam.

3. The release agent applicator of claim 2, wherein the open cell foam structure is configured to be an elongated tube, having a hollow interior.

4. The release agent applicator of claim 2, wherein the open cell foam structure is configured to be an amorphous pad.

5. The release agent applicator of claim 2, wherein the open cell foam structure is configured to be a parallelepiped.

6. The release agent applicator of claim 2, wherein the open cell foam structure is configured to be a disk.

7. The release agent applicator of claim 3, further comprised of a sleeve extending through the hollow interior of the tube.

8. The release agent applicator of claim 7, wherein the sleeve and tube are configured to be joined together by a friction fit.

9. The release agent applicator of claim 7, further comprised of an axle extending through the sleeve, the axle being attached to handle that extends away from the axle.

10. The release agent applicator of claim 1, further comprised of a release agent on the foam structure.

11. The release agent applicator of claim 2, wherein the open cell foam structure is a silicon-based foam, having a oxidation temperature/melting point/of approximately 500 degrees Fahrenheit.

12. The release agent applicator of claim 1, wherein the foam structure is comprised of a material selected from the materials listed in 21 C.F.R. §177.2600.

13. The release agent applicator of claim 1, wherein the foam structure material is viscoelastic.

14. A release agent applicator comprising:
an elastic and porous material comprised of cells, a plurality of cells each defined by a wall with at least one opening through which the release agent can pass, the material having a pore density of between about 25 and 400 pores per lineal inch.

15. The release agent applicator of claim 13, wherein the material has a pore density of between about 60 and 100 pores per lineal inch.

16. The release agent applicator of claim 13, wherein the material has a pore density of about 90 pores per lineal inch.

17. The release agent applicator of claim 13, further comprised of a release agent on the foam structure.

18. A method of applying a release agent to a cooking surface comprising the steps of:
immersing an open cell foam structure, into a release agent, the open cell foam structure being comprised of a plurality of cells, the cells defined by a wall with at least one opening through which the release agent can pass;
applying open cell foam structure to the cooking surface; and
translating the open cell foam structure over the cooking surface, thereby distributing the release agent on the cooking surface.

19. The method of claim 17, wherein the open cell foam structure is a silicon-based foam, having a oxidation temperature/melting point/of approximately 500 degrees Fahrenheit.

20. The method of claim 18, wherein the open cell foam structure is an elongated tube, having a hollow interior and wherein the step of translating the open cell foam structure over the cooking surface is comprised of rolling the elongated tube over the cooking surface.

21. The method of claim 18, wherein the open cell foam structure is an amorphous pad.

22. The method of claim 18, wherein the open cell foam structure is a parallelepiped.
